(19) United States
(12) Patent Application Publication
(10) Pub. No.: US 2013/0029976 A1
(43) Pub. Date: Jan. 31, 2013

(54) PEST CONTROLLING COMPOSITION

(71) Applicant: Yasutaka Shimokawatoko, Kobe-shi (JP)

(72) Inventor: Yasutaka Shimokawatoko, Kobe-shi (JP)

(73) Assignee: SUMITOMO CHEMICAL COMPANY, LIMITED, Tokyo (JP)

(21) Appl. No.: 13/641,420

(22) PCT Filed: Apr. 11, 2011
(86) PCT No.: PCT/JP2011/059464

§ 371 Date: Oct. 15, 2012

(30) Foreign Application Priority Data
Apr. 28, 2010 (JP) 2010-104094
Jan. 19, 2011 (JP) 2011-008515

(51) Int. Cl. A01N 43/84; A01P 15/00

(52) U.S. Cl. 514/229.2

(57) ABSTRACT

A pest controlling composition comprising pyridalyl and indoxacarb.

### TECHNICAL FIELD

The present invention relates to a pest controlling composition and a method for controlling pests.

### BACKGROUND ART

For the purpose of controlling pests, various compounds have hitherto been found or developed, and pest controlling agents containing the compounds as active ingredients have been used. As an active ingredient of the pest controlling agent, for example, pyridalyl(2-[3-[2,6-dichloro-4-[(3,3-dichloro-2-propenyl)oxy]phenoxy]propoxy]-5-(trifluoromethyl)pyridine) (for example, see JP-A-9-151172) has been known.

Indoxacarb(methyl(4aS)-7-chloro-2,5-dihydro-2-[[(meth oxycarbonyl)[4-(trifluoromethoxy)phenyl]amino]carbonyl]indeno[1,2-e] [1,3,4]oxadiazine-4a(3H)-carboxylate) has been known as an active ingredient of the pest controlling agent (for example, see Pamphlets of International Publications WO 92/11249 and WO 95/29171).

### DISCLOSURE OF THE INVENTION

The present invention provides a pest controlling composition having an excellent control effect against pests, and a method for controlling pests.

The present inventor intensively studied so as to find a pest controlling composition having an excellent control effect against pests and a method for controlling pests and found that a pest controlling composition containing pyridalyl and indoxacarb has an excellent control effect against pests, thus accomplishing the present invention.

That is, the present invention is as follows:

[1] A pest controlling composition comprising pyridalyl and indoxacarb.

[2] The pest controlling composition according to [1], wherein the weight ratio of pyridalyl to indoxacarb is within the range from 100:1 to 1:100.

[3] A method for controlling pests, comprising the step of applying an effective amount of pyridalyl and indoxacarb to pests or a place where pests inhabit.

[4] The method for controlling pests according to [3], wherein pyridalyl and indoxacarb are applied in the weight ratio within the range from 100:1 to 1:100.

According to the present invention, it is possible to provide a pest controlling composition having an excellent control effect against pests, and a method for controlling pests.

### MODE FOR CARRYING OUT THE INVENTION

The pest controlling composition of the present invention contains pyridalyl and indoxacarb.

Pyridalyl can be produced, for example, by the method described in JP-A-9-151172.

Indoxacarb can be produced, for example, by the method described in Pamphlet of International Publication No. WO 92/11249.

In the pest controlling composition of the present invention, the weight ratio of pyridalyl to indoxacarb is usually within the range from 100:1 to 1:100, and preferably within the range from 10:1 to 1:10.

The pest controlling composition of the present invention may be a simple mixture of pyridalyl and indoxacarb, or may be one formulated into emulsifiable concentrates, flowable formulations, wettable powders, granular wettable powders, dusts, granules and the like by mixing pyridalyl, indoxacarb and an inert carrier and optionally adding surfactants and other adjuvants for formulation.

The pest controlling composition of the present invention contains pyridalyl and indoxacarb in the total amount of usually within the range from 0.01 to 90% by weight, and preferably within the range from 0.1 to 80% by weight.

Examples of the inert carrier used in the case of formulation include a solid carrier, a liquid carrier and a gas carrier.

Examples of the solid carrier include fine powers and granules of minerals such as kaolin clay, attapulgite clay, bentonite, montmorillonite, acid clay, pyrophyllite, talc, diatomite, and calcite; natural organic substances such as corncob powder, and walnut shell powder; synthetic organic substances such as urea, and urea formaldehyde resins; salts such as calcium carbonate, and ammonium sulfate; and synthetic inorganic substances such as synthetic hydrous silicon oxide.

Examples of the liquid carrier include aromatic hydrocarbons such as xylene, alkylbenzene, and methylnaphthalene; alcohols such as 2-propanol, ethylene glycol, propylene glycol, and ethylene glycol monoethyl ether; ketones such as acetone, cyclohexanone, and isophorone; vegetable oils such as soybean oil, and cottonseed oil; petroleum-based aliphatic hydrocarbons; esters; dimethylsulfoxide; acetonitrile and water.

Examples of the gaseous carrier include fluorocarbon, a butane gas, LPG (liquefied petroleum gas), dimethylether, and carbon dioxide.

Examples of the surfactant include anionic surfactants such as an alkylsulfuric acid ester salt, an alkylarylsulfonic acid salt, a dialkylsulfosuccinic acid salt, a polyoxyethylene alkylaryl ether phosphoric acid ester salt, a lignin sulfonic acid salt, naphthalenesulfonate polycondensed with formaldehyde, a styrene-acrylic acid copolymer, and sodium methyl oleyl taurate; nonionic surfactants such as polyoxyethylene alkyl aryl ether, a polyoxyethylene-alkylpolyoxypropylene block copolymer, and sorbitan fatty acid ester; and cationic surfactants such as an alkyltrimethyl ammonium salt.

Examples of the other adjuvants for formulation include water-soluble polymers such as polyvinyl alcohol and polyvinyl pyrrolidone; gum arabic; alginic acid and a salt thereof; polysaccharides such as CMC (carboxymethyl cellulose) and xanthan gum; inorganic substances such as aluminum magnesium silicate, smectite and alumina sol; preservatives such as 5-chloro-2-methyl-4-isothiazolin-3-one, 1,2-benzothiazolin-3-one and 2-bromo-2-nitropropane-1,3-diol; colorants; and stabilizing agents such as PAP (isopropyl acidic phosphate) and BHT (2,6-di-tert-butyl-4-methylphenol).

Examples of the pests against which the pest controlling composition of the present invention has a control effect include arthropods such as insects and mites; and nemathelminthes such as nematodes. Specific examples of the pests include the followings.

Hemiptera: Delphacidae such as Laodelphax striatellus, Nilaparvata lugens, and Sogatella furcifera, Deltocephalidae such as Nephotettix cincticeps, and Nephotettix virescens, Aphididae such as Aphis gossypii, Myzus persicae, Brevicoryne brassicae, Macrosiphum euphorbiae, Aulacorthum solani, Rhopalosiphum padi, and Toxoptera citricidus, Pentatomidae such as Nezara antennata, Riptortus clavetus, Leptocorisa chinensis, Eysarcoris parvus, Halyomorpha mista, and Lygus lineolaris, Aleyrodidae such as Trialeurodes vaporariorum, Bemisia tabaci, Bemisia argentifolii, and Aleurocanthus spiniferus, scales such as Aonidiella aurantii, Comstockaspis perniciosa, Unaspis citri, Ceroplastes rubens, Icerya purchasi, and Pseudaulacapsis pentagona, Tingidae, and Psyllidae, and the like;

Lepidoptera: Pyralidae such as Chilo suppressalis, Tryporyza incertulas, Cnaphalocrocis medinalis, Notarcha derogata, Plodia interpunctella, Ostrinia furnacalis, Ostrinia nubilaris, Hellula undalis, and Pediasia teterrellus, Noctuidae such as Spodoptera litura, Spodoptera exigua, Pseudaletia separata, Mamestra brassicae, Agrotis ipsilon, Plusia nigrisigna, Trichoplusia spp., Heliothis spp., and Helicoverpa spp., Pieridae such as Pieris rapae, Tortricidae such as Adoxophyes spp., Grapholita molesta, Leguminivora glycinivorella, Matsumuraeses azukivora, Adoxophyes orana fasciata, Adoxophyes sp., Homona magnanima, Archips fuscocupreanus, and Cydia pomonella, Gracillariidae such as Caloptilia theivora, and Phyllonorycter ringoneella, Carposinidae such as Carposina niponensis, Lyonetiidae such as Lyonetia spp., Lymantriidae such as Lymantria spp., and Euproctis spp., Yponameutidae such as Plutella xylostella, Gelechiidae such as Pectinophora gossypiella, and Phthorimaea operculella, Arctiidae such as Hyphantria cunea, and Tineidae such as Tinea translucens, and Tineola bisselliella, and the like;

Thysanoptera: Thripidae such as Frankliniella occidentalis, Thrips palmi, Scirtothrips dorsalis, Thrips tabaci, Frankliniella intonsa, and Frankliniella fusca, and the like;

Diptera: Musca domestica, Culex popiens pallens, Tabanus trigonus, Hylemya antiqua, Hylemya platura, Anopheles sinensis, Agromyzidae such as Agromyza oryzae, Hydrellia griseola, Chlorops oryzae, and Liriomyza trifolii, Dacus cucurbitae, and Ceratitis capitata, and the like;

Coleoptera: Epilachna vigintioctopunctata, Aulacophora femoralis, Phyllotreta striolata, Oulema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata, Agriotes spp., Lasioderma serricorne, Anthrenus verbasci, Tribolium castaneum, Lyctus brunneus, Anoplophora malasiaca, and Tomicus piniperda, and the like;

Orthoptera: Locusta migratoria, Gryllotalpa africana, Oxya yezoensis, and Oxya japonica, and the like;

Hymenoptera: Athalia rosae, Acromyrmex spp., and Solenopsis spp., and the like;

Blattodea: Blattella germanica, Periplaneta fuliginosa, Periplaneta americana, Periplaneta brunnea, and Blatta orientalis, and the like;

Acarina: Tetranychidae such as Tetranychus urticae, Panonychus citri, and Oligonychus spp., Eriophyidae such as Aculops pelekassi, Tarsonemidae such as Polyphagotarsonemus latus, Tenuipalpidae, Tuckerellidae, Acaridae such as Tyrophagus putrescentiae, Dermanyssidae such as Dermatophagoides farinae, and Dermatophagoides ptrenyssnus, Cheyletidae such as Cheyletus eruditus, Cheyletus malaccensis, and Cheyletus moorei, and the like;

Nematodes: Aphelenchoides besseyi, Nothotylenchus acris, and the like.

The method for controlling pests of the present invention includes the step of applying an effective amount of pyridalyl and indoxacarb to pests or a place where pests inhabit.

Examples of the place where pests inhabit include crops and soil in which crops are grown.

The method for controlling pests of the present invention can be carried out by applying the pest controlling composition of the present invention to pests or a place where pests inhabit. The method for controlling pests of the present invention can also be carried out by separately applying pyridalyl and indoxacarb to pests or a place where pests inhabit.

In the method for controlling pests of the present invention, the weight ratio of pyridalyl to indoxacarb to be applied is usually within the range from 100:1 to 1:100, and preferably within the range from 10:1 to 1:10.

In the method for controlling pests of the present invention, examples of a method of applying pyridalyl and indoxacarb to a place where pests inhabit include a method of spraying pyridalyl and indoxacarb to foliage of crops, a method of irrigating pyridalyl and indoxacarb to soil in which crops are grown, and a method of treating seeds of crops with pyridalyl and indoxacarb.

In the case where pyridalyl and indoxacarb are applied to foliage of crops or soil in which crops are grown, the application amount varies depending upon the kinds of crops to be treated, the kinds of pests to be controlled, the degree of incidence of pests to be controlled, formulation, treatment period, meteorological conditions, and the like. The total amount of pyridalyl and indoxacarb is usually within the range from 0.1 to 1,000 g, and preferably within the range from 1 to 200 g, per 10,000 m² of soil.

In the case where pyridalyl and indoxacarb are formulated into emulsifiable concentrates, wettable powders, flowable formulations and the like, these formulations are usually applied by spraying after diluting with water. In this case, formulations are diluted to adjust the total concentration of pyridalyl and indoxacarb usually to within the range from 1 to 10,000 ppm, and preferably to within the range from 10 to 500 ppm.

In the case where pyridalyl and indoxacarb are formulated into dusts, granules and the like, these formulations are usually applied without dilution.

In the case where seeds of crops are treated with pyridalyl and indoxacarb, the treatment amount, expressed by the total amount of pyridalyl and indoxacarb, is usually within the range from 0.001 to 20 g per kg of seeds, and preferably within the range from 0.01 to 10 g per kg of seeds.

The pest controlling composition of the present invention can be used to control pests of plants included in the following “crops”. These plants are non-limiting examples.

### “Crops”:

Agricultural Crops: corn, wheat, barley, rye, oat, sorghum, cotton, soybean, peanut, sarrazin, sugar beet, rapeseed, sunflower, sugar cane, tobacco, and the like;

Vegetables: Solanaceae vegetables (eggplant, tomato, green pepper, hot pepper, potato, and the like), Cucurbitaceae vegetables (cucumber, pumpkin, zucchini, watermelon, melon, and the like), Cruciferae vegetables (Japanese radish, turnip, horseradish, kohlrabi, Chinese cabbage, cabbage, brown mustard, broccoli, cauliflower, and the like), Compositae vegetables (burdock, garland chrysanthemum, artichoke, lettuce, and the like), Liliaceae vegetables (Welsh onion, onion, garlic, asparagus, and the like), Umbelliferae vegetables (carrot, parsley, celery, parsnip, and the like), Chenopodiaceae vegetables (spinach, Swiss chard, and the like), Labiatae vegetables (Japanese basil, mint, basil, and the like), strawberry, sweet potato, yam, aroid, and the like;

Flowers and Ornamental Plants: acanthus, morning glory, azalea, hydrangea, anemone raddeana, spring starflower, anemone; polygonatum odoratum, amaryllis, iris, alyssum, armeria, arctotis, China aster, edible flower, Bauera ruibioides, Cuban lily, Hosta montana, Mexican aster, Mirabilis jalapa, Hypericum, oriental poppy, Gentiana makinoi, Hosta aureomarginata, Japanese iris, Clematis patens, gazania, Casa Blanca, carnation, showy lily, gerbera, kalanchoe, calceolaria, curry plant, Carolina jasmine, canna, chrysanthemum, Brugmansia, yellow cosmos, plantain lily, KimJongilia, Manuka, pot marigold, myrtle, nasturtium, gladiolus, Siam tulip, clematis, cockscomb, shrimp plant, midday flower, cosmos, Hosta sieboldii, Convolvulus arvensis, Hosta sagae, primrose, saffron crocus, salvia, cyclamen, moss phlox, Paeonia lactiflora, Anemone hupehensis, Bletilla striata, sweet pea, lily of valley, snowflake, portulaca, violet, rose of sharon, yarrow, Chinese pink, zephyranthes, Pelargonium, Geum, zepher lily, dahlia, tithonia, tulip, chocolate cosmos, Vinca major, Scilla, downy myrtle, German iris, passion flower, dianthus, rape blossom, Madagascar periwinkle, wind flower, nemophila, Nerine, swamp chrysanthemum (North pole), Iris ensata var. spontanea, verbena, hibiscus, Joseph's coat, coral flower, Iris ensata, eastern redbud, spring starflower, wavyleaf sea-lavender, California poppy, pansy, Virginia stock, daisy, corn poppy, Himalayan creeping saxifrage, sunflower, hyacinth, crape-myrtle, Geranium, fuchsia, freesia, primula, garden balsam, ground cherry, peony, Tricyrtis, marguerite, marigold, Gymnaster savatieri, strawflower, muscari, Japanese kerria, lily, ranunculus, lantana, Japanese gentian, Lupinus, lobelia, and the like;

Ornamental Foliage Plants: ivy, acalypha, aglaonema, adiantum, asparagus, asplenium, ananas, aphelandra, alocasia, anthurium, Indian rubber tree, nepenthes, aechmea, aeschynanthus, episcia, augusta, spiders plant, Chinese banyan, kapok, caladium, calathea, velvet plant (Gynura), Guzumania, Ctenanthe, gum tree, crassula, croton, Alocasia odora, orange jessamine, coffee tree, massangeana, conifers, coleus, cordyline, columnea, snake plant, Sansevieria trifasciata, Chinese ixora, schefflera, cissus, cyperus, reed rhapis, silk jessamine, syngonium, strelitzia, spathiphyllum, senecio, zebrina, Japanese sago palm, tillandsia, tupidanthus, Indian coral tree, dizygotheca, dieffenbachia, duranta, bottle palm, dracaena, tradescantia, neoregelia, nephrolepis, hearts vine, hibiscus, pachypodium, Guiana chestnut (Pachira), ponytail, staghorn fern, pilea, fatshedera, ficus pumila, philodendron, bougainvillea, phoenix, fittonia, pteris, bridal veil, vriesea, plectranthus, begonia, peperomia, heliconia, benjamina, poinsettia, pothos, Hoya carnosa, maranta, Belgian evergreen, milkbush, oyster plant, monstera, palm, yucca, lantana, and the like;

Fruit Trees: pomaceous fruits (apple, common pear, Japanese pear, Chinese quince, quince, and the like), stone fleshy fruits (peach, plum, nectarine, Japanese plum, cherry, apricot, prune, and the like), citrus plants (Satsuma mandarin, orange, lemon, lime, grapefruit, and the like), nuts (chestnut, walnut, hazel nut, almond, pistachio, cashew nut, macadamia nut, and the like), berry fruits (blueberry, cranberry, blackberry, raspberry, and the like), grape, persimmon, olive, loquat, banana, coffee, date, coconut, and the like; and

Trees Other Than Fruit Trees: tea, mulberry, flowering trees and shrubs, street trees (ash tree, birch, dogwood, eucalyptus, ginkgo, lilac, maple tree, oak, poplar, cercis, Chinese sweet gum, plane tree, zelkova, Japanese arborvitae, fir tree, Japanese hemlock, needle juniper, pine, spruce, yew), and the like.

The above “crops” also include those which are provided, by way of a classical breeding method or genetic engineering technology, with resistance to: 4-hydroxyphenylpyruvic acid dioxygenase inhibitors such as isoxaflutole; acetolactate synthase (hereinafter referred to as ALS) inhibitors such as imazethapyr and thifen sulfuronmethyl; 5-enolpyruvylshikimate-3-phosphate synthase (hereinafter referred to as EPSP) inhibitors such as glyphosate; glutamine synthase inhibitors such as glufosinate; auxin type herbicides such as 2,4-D and dicamba; herbicides such as bromoxynil.

Examples of the “crops” provided with resistance by a classic breeding method include corn and canola having resistance to imidazolinone-based ALS inhibitor-type herbicides such as imazethapyr, which have been already on the market under the trade name of Clearfield (trade mark). Likewise, there is STS soybean or the like which has resistance to sulfonyl urea-based ALS inhibitor-type herbicides such as thiofen sulfuronmethyl. Likewise, there is SR corn or the like as an example of a plant which is provided with resistance to acetyl CoA carboxylase inhibitors, such as trione oxime-based and aryloxy phenoxypropionic acid-based herbicides, by a classical breeding method. Examples of the plant provided with resistance to the acetyl CoA carboxylase inhibitors are described in Proc. Natl. Acad. Sci. USA, Vol. 87, pp. 7175-7179 (1990) or the like.

Examples of the “crops” provided with herbicidal resistance by a genetic engineering technology include corn, soybean and cotton having resistance to glyphosate or glufosinate, which have been already on the market under the trade names of Roundup Ready (trademark), Liberty Link (trade mark), Optimum GAT (trade mark) and the like.

Mutated acetyl CoA carboxylase, which is resistant to the acetyl CoA carboxylase inhibitor, is reported in Weed Science, Vol. 53, pp. 728-746 (2005). Plants with resistance to the acetyl CoA inhibitor are fabricated by introducing such a mutated acetyl CoA carboxylase gene into the plants by a genetic engineering technology, or by introducing resistance-providing mutation into acetyl CoA carboxylase of the plants. Further, by introducing base substitution mutation nucleic acid into a plant cell to induce site-specific amino acid substitution mutation to the acetyl CoA carboxylase gene, ALS gene, and the like of the plant, which is typified by chimeraplasty technology (Gura T., Repairing The Genome's Spelling Mistakes, Science 285: 316-318 (1999)), plants resistant to acetyl CoA carboxylase inhibitors and ALS inhibitors are fabricated.

By introducing a degrading enzyme of dicamba, such as dicamba monooxygenase isolated from Pseudomonas maltophilia into plants, crops such as soybean resistant to dicamba can be fabricated (Behrens et al. 2007 Dicamba Resistance: Enlarging and Preserving Biotechnology-Based Weed Management Strategies. Science 316:1185-1188).

By introducing a gene encoding aryloxyalkanoate dioxygenase, crops resistant to both phenoxy acid-based herbicides such as 2,4-D, MCPA, dichlorprop and mecoprop, and aryloxyphenoxypropionic acid-based herbicides such as quizalofop, haloxyfop, fluazifop, diclofop, fenoxaprop, metamifop, cyhalofop, and clodinafop can be fabricated (WO 2005/107437, WO 2007/053482, and WO 2008/141154).

The above “crops” also include crops which make it possible to synthesize-insecticidal proteins known as genus Bacillus, using a genetic engineering technology.

Examples of the toxins expressed in such genetically modified plants include insecticidal proteins derived from Bacillus cereus and Bacillus popilliae; δ-endotoxins derived from Bacillus thuringiensis, e.g. Cry1Ab, Cry1Ac, Cry1F, Cry1Fa2, Cry2Ab, Cry3A, Cry3Bb1 and Cry9C, and insecticidal proteins such as VIP1, VIP2, VIP3 and VIP3A; insecticidal toxins derived from nematodes; toxins produced by animals, such as scorpion toxin, spider toxin, bee toxin and insect-specific neurotoxins; filamentous fungi toxins; plant lectins; agglutinin; protease inhibitors such as trypsin inhibitors, serine protease inhibitor, patatin, cystatin and papain inhibitors; ribosome-inactivating proteins (RIPs) such as ricin, corn-RIP, abrin, rufin, sapolin and priodin; steroid metabolic enzymes such as 3-hydroxysteroid oxidase, ecdysteroid-UDP-glucosyltransferase and cholesterol oxidase; ecdysone inhibitors; HMG-COA reductase; ion channel inhibitors such as a sodium channel inhibitors and calcium channel inhibitors; juvenile hormone esterase; diuretic hormone receptors; stilbene synthase; bibenzyl synthase; chitinase; and glucanase, and the like.

The toxins expressed in such genetically modified plants include δ-endotoxin proteins such as Cry1Ab, Cry1Ac, Cry1F, Cry1Fa2, Cry2Ab, Cry3A, Cry3Bb1, Cry9C, Cry34Ab and Cry35Ab, hybrid toxins of insecticidal proteins such as VIP1, VIP2, VIP3 and VIP3A, partially deficient toxins, and modified toxins.

The hybrid toxins are fabricated by a novel combination of the different domains of such proteins, using a genetic engineering technology.

A known partially deficient toxin is Cry1Ab, in which a part of amino acid sequence is deficient.

In modified toxins, one or more amino acids of natural toxins are replaced.

Examples of such toxins and genetically modified plants capable of synthesizing such toxins are described in EP-A-0 374 753, WO 93/07278, WO 95/34656, EP-A-0 427 529, EP-A-451 878, WO 03/052073 and the like.

The toxins contained in such genetically modified plants impart resistance to insect pests of Coleoptera, insect pests of Diptera, insect pests of Lepidoptera to the plants.

It has already been known that there are genetically modified crops containing one or more insecticidal pest-resistant genes and capable of expressing one or more toxins. Some of them are commercially available.

Examples of such genetically modified crops include YieldGard (trade mark) (corn cultivar expressing a Cry1Ab toxin), YieldGard Rootworm (trade mark) (corn cultivar expressing a Cry3Bb1 toxin), YieldGard Plus (trade mark) (corn cultivar expressing Cry1Ab and Cry3Bb1 toxins), Herculex I (trade mark) (corn cultivar expressing phosphinotrysin N-acetyltransferase (PAT) for imparting resistance to a Cry1Fa2 toxin and Glufosinate) , NuCOTN33B (trademark) (cotton cultivar expressing a Cry1Ac toxin), Bollgard I (trade mark) (cotton cultivar expressing a Cry1Ac toxin), Bollgard II (trade mark) (cotton cultivar expressing Cry1Ab and Cry2Ab toxins), VIPCOT (trade mark) (cotton cultivar expressing a VIP toxin), NewLeaf (trade mark) (potato cultivar expressing a Cry3A toxin), NatureGard (trade mark) Agrisure (trade mark) GT Advantage (GA21 Glyphosate resistance trait), Agrisure (trade mark) CB Advantage (Bt11 corn borer (CB) trait), and Protecta (trade mark) and the like.

Plants used as the subject to be treated with the pest controlling composition or the method for controlling pests of the present invention also include plants provided with resistance to aphid, such as soybean containing Resistance Aphid Gene 1 (Rag1) introduced thereinto.

The above “crops” include those to which a capacity of producing an anti-pathogenic substance having selective action has been imparted by using a genetic engineering technology.

As the anti-pathogenic substance, for example, PR proteins are known (PRPs, described in EP-A-0 392 225). These anti-pathogenic substances and genetically modified plants which produce the substances are described in EP-A-0 392 225, WO 95/33818, EP-A-0 353 191 and the like.

Examples of anti-pathogen substances expressed in such genetically modified plants include ion channel inhibitors such as sodium channel inhibitors and calcium channel inhibitors (KP1, KP4, KP6 toxins, and the like produced by virus are known); stilbene synthase; bibenzyl synthase; chitinase; glucanase; PR proteins; anti-pathogenic substances produced by microorganisms such as peptide antibiotics, antibiotics having a heterocycle, and protein factors relating to resistance against palant pathogens (described in WO 03/000,906).

The above “crops” include plants to which useful traits, such as reformed oil component and enhanced amino acid content, have been imparted by using a genetic engineering technology. Examples thereof include VISTIVE (trade mark) (low linolenic soybean with reduced linolenic acid content), and high-lysine (high-oil) corn (corn with increased lysine or oil content).

The above “crops” further include stacked varieties, which are fabricated by combining useful traits such as the above classical herbicidal traits or herbicide resistant genes, insecticidal pest resistant genes, anti-pathogenic substance-producing genes, reformed oil component and enhanced amino acid content.

In the present invention, pest controlling agents such as various insecticides, acaricides, nematocides, fungicides, herbicides, plant hormone agents and plant growth regulators; synergists, safeners, pigments, fertilizers, soil conditioners, feeds for animals and the like may be used in combination with pyridalyl and indoxacarb.

### EXAMPLES

The present invention will be further described by way of formulation examples and test examples, but the present invention is not limited to these examples.

First, formulation examples are described. Parts are parts by weight.

### Formulation Example 1

Pyridalyl (5 parts), 5 parts of indoxacarb, 8 parts of polyoxyethylene styryl phenyl ether, 2 parts of calcium dodecylbenzene sulfonate and 80 parts of xylene are mixed to obtain an emulsifiable concentrate.

### Formulation Example 2

Pyridalyl (20 parts), 4 parts of indoxacarb, 3 parts of sodium dodecylbenzene sulfonate, 3 parts of sodium ligninsulfonate and 70 parts of diatomaceous earth are ground by a jet air mill to obtain a wettable powder.

### Formulation Example 3

Pyridalyl (1 part), 0.5 parts of indoxacarb, 48.5 parts of talc and 50 parts of clay are mixed to obtain a dust.

### Formulation Example 4

Pyridalyl (1 part), 4 parts of indoxacarb, 5 parts of sodium dodecylbenzene sulfonate, 30 parts of bentonite and 60 parts of clay are mixed. Then, an appropriate amount of water is added to the mixture and the mixture is kneaded. The kneaded mixture is granulated by a granulating machine and subjected to air drying to obtain a formulation.

### Formulation Example 5

Polyoxyethylene styryl phenyl ether sulfate (5 parts), 20 parts of an aqueous 1% xanthan gum solution, 3 parts of a smectite mineral and 60 parts of water are mixed. To the mixture, 5 parts of pyridalyl and 5 parts of indoxacarb are added, followed by stirring and further dispersion to obtain a flowable formulation.

### Formulation Example 6

Pyridalyl (0.1 parts) and 0.02 parts of indoxacarb are dissolved in 10 parts of acetone. The obtained solution is uniformly mixed with 99.88 parts of a solid feed powder for animals (Breeding Solid Feed Powder CE-2, manufactured by Japan Clea Co., Ltd.) and then the mixture is air-dried to remove acetone, and thus a poison bait is obtained.

Next, test examples are described with respect to the control of pests according to the present invention.

### Test Example 1

A flowable formulation containing 10.0% by weight of pyridalyl (trade name: Pleo® flowable, manufactured by Sumitomo Chemical Co., Ltd.) was diluted with water containing 0.02% by volume of a spreading agent (trade name: Sindain®, manufactured by Sumitomo Chemical Co., Ltd.) so as to adjust the concentration of pyridalyl to 12.5 ppm.

A flowable formulation containing 10.0% by weight of indoxacarb (trade name: Tornado® flowable, manufactured by DuPont) was diluted with water containing 0.02% by volume of a spreading agent (trade name: Sindain®, manufactured by Sumitomo Chemical Co., Ltd.) so as to adjust the concentration of indoxacarb to 6.25 ppm.

The water dilution of pyridalyl and the water dilution of indoxacarb were mixed in the same amount to prepare a test chemical solution.

A cabbage was planted in a pot having a volume of 860 ml and grown to the forth leaf stage. Each leaf of the cabbage seedling was cut off. One leaf of the cabbage was immersed in the test chemical solution for 60 seconds. After air-drying, the leaf was placed in a cup having a volume of 500 ml in which filter paper had been spread on the bottom. In the cup, 10 third instar larvae of Spodoptera litura were released (the inside of the cup containing the treated cabbage was regarded as the treated area).

On the other hand, without immersion in the test chemical solution and air drying, another leaf of the cabbage was placed in a cup having a volume of 500 ml in which filter paper had been spread on the bottom. In the cup, 10 third instar larvae of Spodoptera litura were released (the inside of the cup containing the non-treated cabbage was regarded as the non-treated area). Two (2) days after, life or death of tested insects was observed in the treated area and the non-treated area, respectively, and then mortality was determined by the following equation.

Mortality (%)=100×[(the number of test insects−the number of alive insects)/the number of test insects]

An insecticidal ratio was calculated by correcting the results using the following equation. The test was carried out in three replications.

The results are shown in Table 1.

Insecticidal ratio (%)=100×(Mt−Mc)/(100−Mc)

Mt: Mortality (%) in the treated area

Mc: Mortality (%) in the non-treated area of test compound

TABLE 1

| Active | Concentration of active | Insecticidal |
|---|---|---|
| ingredient | ingredient [ppm] | ratio (%) |
| Pyridalyl + | 6.25 + 3.13 | 63.3 |
| Indoxacarb | | |
| Pyridalyl | 6.25 | 10.0 |
| Indoxacarb | 3.13 | 16.7 |

### Test Example 2

A flowable formulation containing 10.0% by weight of pyridalyl (trade name: Pleo® flowable, manufactured by Sumitomo Chemical Co., Ltd.) is diluted with water containing 0.02% by volume of a spreading agent (trade name: Sindain®, manufactured by Sumitomo Chemical Co., Ltd.) so as to adjust the concentration of pyridalyl to 200 ppm.

A flowable formulation containing 10.0% by weight of indoxacarb (trade name: Tornado® flowable, manufactured by DuPont) is diluted with water containing 0.02% by volume of a spreading agent (trade name: Sindain®, manufactured by Sumitomo Chemical Co., Ltd.) so as to adjust the concentration of indoxacarb to 100 ppm.

The water dilution of pyridalyl and the water dilution of indoxacarb are mixed in the same amount to prepare a test chemical solution.

A cabbage is planted in a pot having a volume of 860 ml and grown to the forth leaf stage. Each leaf of the cabbage is cut off. One leaf of the cabbage is immersed in the test chemical solution for 60 seconds. After air-drying, the leaf is placed in a cup having a volume of 500 ml in which filter paper has been spread on the bottom. In the cup, 10 third instar larvae of Spodoptera litura are released (the inside of the cup containing the treated cabbage is regarded as the treated area).

On the other hand, another leaf of the cabbage is placed in a cup having a volume of 500 ml in which filter paper has been spread on the bottom without immersion in the test chemical solution and air drying. In the cup, 10 third instar larvae of Spodoptera litura are released (the inside of the cup containing the non-treated cabbage is regarded as the non-treated area). Four (4) days after, life or death of tested insects is observed in the treated area and the non-treated area, respectively, and then mortality is determined by the following equation.

Mortality (%)=100×(the number of dead insects/the number of test insects)

An insecticidal ratio is calculated by correcting the results using the following equation. The test is carried out in three replications.

As a result of the test, the test chemical solution shows a high insecticidal ratio.

Insecticidal ratio (%)=100×(Mt−Mc)/(100−Mc)

Mt: Mortality (%) in the treated area

Mc: Mortality (%) in the non-treated area

1. A pest controlling composition comprising pyridalyl and indoxacarb.

2. The pest controlling composition according to claim 1, wherein the weight ratio of pyridalyl to indoxacarb is within the range from 100:1 to 1:100.

3. A method for controlling pests, comprising the step of applying an effective amount of pyridalyl and indoxacarb to pests or a place where pests inhabit.

4. The method for controlling pests according to claim 3, wherein pyridalyl and indoxacarb are applied in the weight ratio within the range from 100:1 to 1:100.
